(19) United States
(12) Patent Application Publication
(10) Pub. No.: US 2020/0216249 A1
(43) Pub. Date: Jul. 9, 2020

(54) PLASTIC CORRUGATED CONTAINER WITH SOFT SCORE LINE

(71) Applicant: ORBIS Corporation, Oconomowoc, WI (US)

(72) Inventor: Donald J. Balazs, Oconomowoc, WI (US)

(21) Appl. No.: 16/822,107

(22) Filed: Mar. 18, 2020

Related U.S. Application Data
(63) Continuation of application No. 15/629,806, filed on Jun. 22, 2017, now Pat. No. 10,625,916.
Application No. 15/629,806 is a continuation-in-part of application No. 14/580,810, filed on Dec. 23, 2014.
(60) Provisional application No. 62/354,483, filed on Jun. 24, 2016.
(60) Provisional application No. 61/920,570, filed on Dec. 24, 2013.

(51) Int. Cl. B65D 77/22; B65D 5/42; B31F 1/10; B31B 50/25; B31B 50/26; B65D 65/40

(52) U.S. Cl. CPC B65D 77/22; B65D 5/4266; B31F 1/10; B31B 2105/001; B31B 50/26; B31B 50/252; B65D 65/403; B31B 50/256

(57) ABSTRACT

A box formed from a plastic corrugated material with soft score lines is provided. The soft score lines are formed to enable the top flaps of the box to lay substantially flat against the outer surface of the box when folded to an open position.

### CROSS-REFERENCE TO RELATED APPLICATIONS

The present application is a continuation of U.S. patent application Ser. No. 15/629,806, filed Jun. 22, 2017, which claims the benefit of U.S. Provisional Application No. 62/354,483, filed Jun. 24, 2016, the contents of which are incorporated herein by reference. U.S. patent application Ser. No. 15/629,806 is a continuation-in-part of U.S. application Ser. No. 14/580,810, filed Dec. 23, 2014, which claims the benefit of U.S. Provisional Application No. 61/920,570, filed Dec. 24, 2013, the contents of which are also incorporated herein by reference.

### FEDERALLY SPONSORED RESEARCH OR DEVELOPMENT

N/A

### FIELD OF THE INVENTION

The present invention generally relates to a plastic corrugated container or box having soft score lines separating the side walls from the flaps to enable the flaps to lay substantially flat against the outer surface of the side walls when in an open position.

### BACKGROUND OF THE INVENTION

In certain instances, it is important to provide box containers which have top flaps that can be fully opened to lay flat against the outside of the box. In particular, automated filling machinery may have narrow passages for such boxes. Flaps that extend outward from the box may get caught in such machinery.

Paperboard boxes can be formed to have flaps that lay flat. However, for plastic corrugated boxes, the plastic in the score lines between the flaps and the side walls has memory that causes the flaps to spring back. This causes the flaps to move back toward a planar relationship with the side walls.

The present invention provides an improved score line for use with plastic corrugated boxes.

### SUMMARY OF THE INVENTION

The present invention provides a plastic corrugated box having flaps that can be folded substantially flat against the outer surfaces of the side walls of the box, and which remain in that position without substantial spring back. That is, the flaps are separated from the side walls by soft or “lazy” score lines that remain substantially flat to provide an opening that can be filled without the need for holding or otherwise restraining the flaps in place.

In accordance with one aspect of the invention, a corrugated plastic box with a soft score line is provided. The box comprises a plurality of side walls formed from a corrugated plastic sheet of material. The box also comprises a first flap extending from a first one of the plurality of side walls. The first flap is also formed from a corrugated plastic sheet of material and is separated from the first one of the plurality of side walls by a first score line. The first score line is configured to allow the first flap to lay substantially flat against an outer surface of the first one of the plurality of side walls when the first flap is folded against the outer surface of the first one of the plurality of side walls.

The corrugated plastic sheets of material include a first outer layer of plastic, a second outer layer of plastic and a plurality of flutes between the first outer layer and the second outer layer. The box can be formed from a single blank of such material.

The first score line is formed to have an inwardly concave radius of 0.01 inches. This matches the radius of a convex rib of an anvil used in conjunction with an ultrasonic horn that can be used to form the score line. The first score line is configured to have substantially no spring back. In this regard, the flap will stay in an open position against the outer surface of the side wall once positioned there without the need for any mechanical restraint to keep it in place.

In addition to the first flap, the box can include the same score line for each of the flaps extending from each of the side walls forming the box. Preferably, this type of score line is used for the top flaps. It can optionally be used for the bottom flaps.

In accordance with another aspect of the invention, a method of forming a plastic box with a soft score line is provided. The method comprises providing a blank of corrugated plastic material having a plurality of side walls and a first flap extending from a first one of the plurality of side walls. The method includes forming a score line between the first flap and the first one of the plurality of side walls sufficiently wide such that the first flap is configured to lay substantially flat against an outer surface of the first one of the plurality of side walls when the first flap is folded against the outer surface of the first one of the plurality of side walls. This can also be done for flaps extending from each of the side walls.

The forming a score line step can comprise applying a rotary ultrasonic horn against the blank. The ultrasonic horn can include a contact segment (e.g., a rib) having a radius of 0.01 inches.

Alternatively, the forming a score line step can comprise applying a plunge ultrasonic horn against the blank, or applying heat and pressure to the blank.

The step of providing a blank of corrugated plastic material can comprise extruding a sheet of plastic having a first outer layer, a second outer layer and a plurality of flutes between the first outer layer and the second outer layer, forming fold lines on the sheet to form the plurality of side walls and cutting the sheet to form flaps extending from each of the plurality of side walls. Once the score line is formed, the method further includes forming the blank into a box shape. This latter step can be performed on automated machinery.

Further aspects of the invention are disclosed in the Figures, and are described herein.

### BRIEF DESCRIPTION OF THE DRAWINGS

To understand the present invention, it will now be described by way of example, with reference to the accompanying drawings in which:

FIG. 1 is a perspective view of a plastic corrugated box having conventional score lines between the top flaps and the side walls;

FIG. 2 is a perspective view of a plastic corrugated box with soft score lines between the top flaps and the side walls in accordance with the present invention

FIG. 3 is a perspective view of an ultrasonic horn for forming the soft score lines of the present inventions;

FIG. 4 is a side plan view of the ultrasonic horn; and,

FIG. 5 is a cross-sectional view of the forming features of the ultrasonic horn.

### DETAILED DESCRIPTION

While this invention is susceptible of embodiments in many different forms, there is shown in the drawings, and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a plastic corrugated box having soft or “lazy” score lines separating the side walls and the flaps. The soft score lines allow the flaps to lay flat against the walls of the box when the flaps are opened. This enables the box to be more effectively filled, especially with automated machinery.

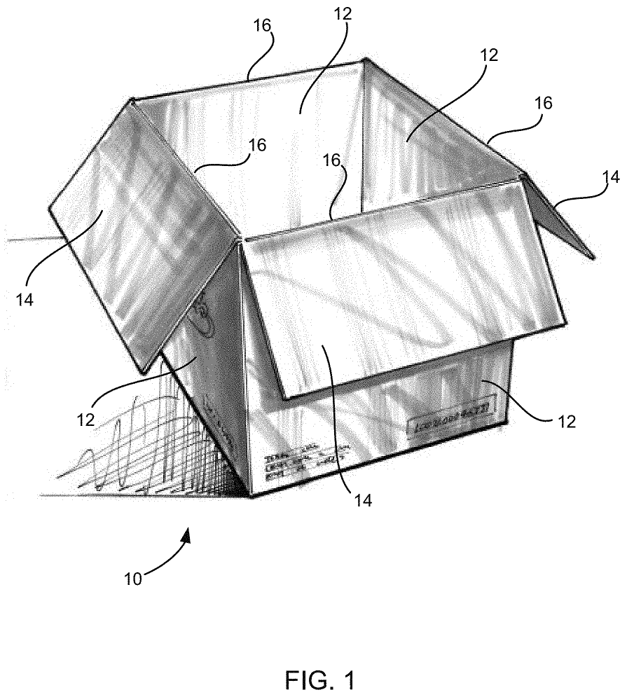

FIG. 1 shows a plastic corrugated box 10 with a plurality of side walls 12, and a plurality of top flaps 14 extending upward from the side walls (one flap for each side wall in this example—however a side wall can include multiple flaps). Typically, the flaps are simply extensions of the same material forming the side wall. Each flap 14 is separated from the respective side wall by a score line 16.

In the example of FIG. 1, the score lines 16 are formed in a conventional manner (here, conventional means both prior developments by the current applicants—which are the subject of pending patent applications—and earlier attempts by others in the industry) which causes the top flaps to tend to spring back. That is, the plastic in the score line retains a certain amount of memory that causes the score line to move the flap back toward a planar position with the side wall. In certain instances this is desired for plastic boxes that are going to be reused in box converting machinery which requires the flaps to be substantially planar with the side walls.

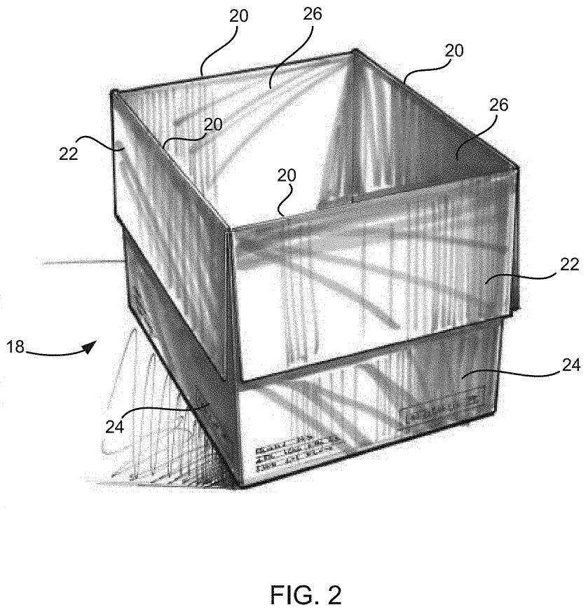

However, the score lines 16 formed in the conventional manner are not useful for situations where the box is filled in automated machinery that requires the top flaps to be substantially flat against the outer surface of the side walls. FIG. 2 shows a plastic corrugated box 18 with score lines 20 that allow the flaps 22 to lay substantially flat against the outer surface 24 of the side walls 26 in accordance with the present invention. As is evident in FIG. 2, the flaps 22 do not spring back to an upright or partial upright position (as that shown in FIG. 1).

The score lines 20 of the present invention are formed without slitting the corrugated plastic in this area. Providing one or more slits can sufficiently weaken the score line to act in a manner similar to that shown in FIG. 2. However, it opens and exposes the flutes in the interior of the corrugated plastic. This allows for water and other contaminants to enter this area.

Instead, in the present invention, the score lines 20 separating the top flaps from the side walls 26 are formed to be soft or “lazy” by reforming the corrugated plastic from the outer walls of the corrugated plastic sheet. Specifically, the score lines 20 are formed to be wider than conventional score lines. This can be done by use of a rotary ultrasonic horn and anvil, a plunge ultrasonic system, or by application of heat and pressure.

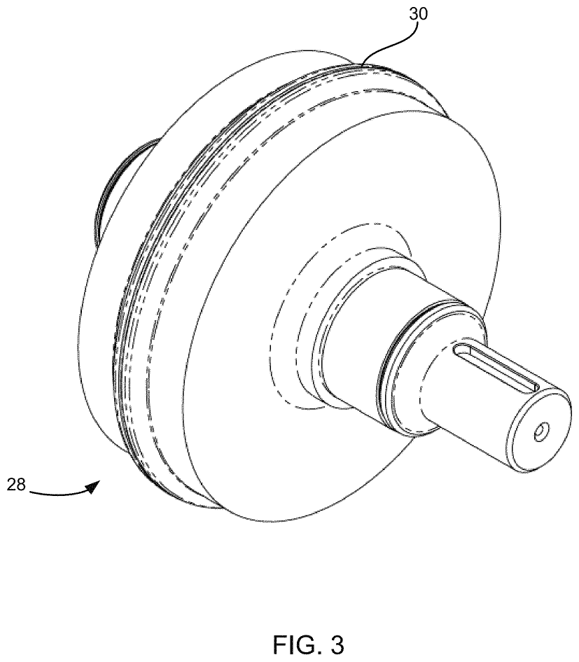

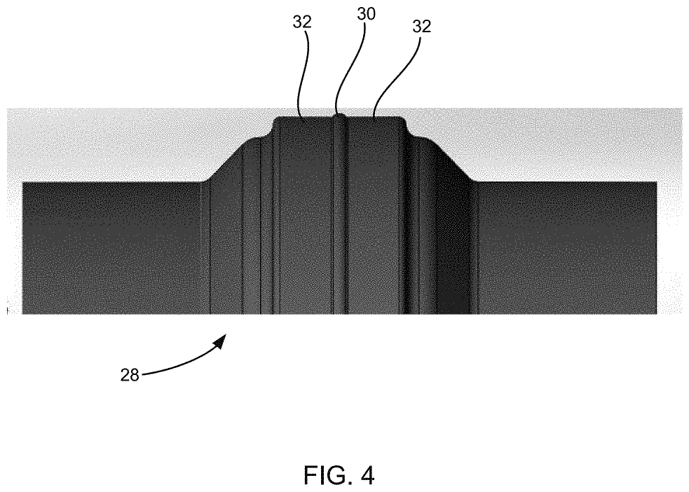

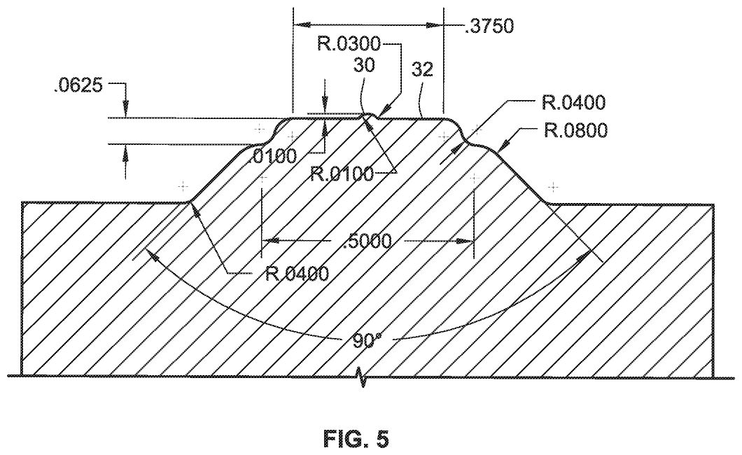

One rotary ultrasonic horn 28 is shown in FIGS. 3-5. The ultrasonic horn 28 is in the form of a roller (see FIG. 3) having a score line forming rib 30. The rib is preferably formed to have a radius of 0.010 inches. The rib 30 blends into a flat portion 32 on either side of the rib 30. The transition from the rib 30 to the flat portions 32 has a radius of 0.030 inches.

The box can be formed from a single sheet of extruded plastic having a first outer sheet, a second outer sheet and a plurality of flutes between the first outer sheet and the second outer sheet. The sheet is then cut into a blank having fold lines separating side walls and cuts between the flaps. After forming the score lines of the present invention, the blank can then be erected in automated box forming machinery.

Many modifications and variations of the present invention are possible in light of the above teachings. It is, therefore, to be understood within the scope of the appended claims the invention may be protected otherwise than as specifically described.

1. A corrugated plastic box with a soft score line comprising:
a plurality of side walls, each of the side walls formed from a corrugated plastic sheet of material;
a first flap extending from a first one of the plurality of side walls, the first flap formed from the corrugated plastic sheet of material and separated from the first one of the plurality of side walls by a first score line wherein the first score line is configured to allow the first flap to lay substantially flat against an outer surface of the first one of the plurality of side walls without spring back when the first flap is folded against the outer surface of the first one of the plurality of side walls.

2. The corrugated plastic box of claim 1 wherein the corrugated plastic sheets of material includes a first outer layer of plastic, a second outer layer of plastic and a plurality of flutes between the first outer layer and the second outer layer.

3. The corrugated plastic box of claim 1 wherein the first score line is formed to have an inwardly concave radius of 0.01 inches.

4. (canceled)

5. The corrugated plastic box of claim 1 further comprising:
a second flap extending from a second one of the plurality of side walls, the second flap formed from the corrugated plastic sheet of material and separated from the second one of the plurality of side walls by a second score line wherein the second score line is configured to allow the second flap to lay flat against an outer surface of the second one of the plurality of side walls without springback when the second flap is folded against the outer surface of the second one of the plurality of side walls.

6. The corrugated plastic box of claim 5 further comprising:
a third flap extending from a third one of the plurality of side walls, the third flap formed from the corrugated plastic sheet of material and separated from the third one of the plurality of side walls by a third score line wherein the third score line is configured to allow the third flap to lay flat against an outer surface of the third one of the plurality of side walls without spring back when the third flap is folded against the outer surface of the third one of the plurality of side walls.

7. The corrugated plastic box of claim 6 further comprising:
a fourth flap extending from a fourth one of the plurality of side walls, the fourth flap formed from the corrugated plastic sheet of material and separated from the fourth one of the plurality of side walls by a fourth score line wherein the fourth score line is configured to allow the fourth flap to lay flat against an outer surface of the fourth one of the plurality of side walls without spring back when the fourth flap is folded against the outer surface of the fourth one of the plurality of side walls.

8. The corrugated plastic box of claim 7 wherein each of the first, second, third and fourth flaps are foldable upward to form a top of the box.

9. The corrugated plastic box of claim 8 further including a plurality of flaps, each of the plurality of flaps connected to one of the plurality of side walls to form a bottom wall of the box.

10. A method of forming a plastic box with a soft score line comprising:
providing a blank of corrugated plastic material, the blank formed to include a plurality of side walls and a first flap extending from a first one of the plurality of side walls;
forming a score line between the first flap and the first one of the plurality of side walls sufficiently wide such that the first flap is configured to lay flat against an outer surface of the first one of the plurality of side walls without spring back when the first flap is folded against the outer surface of the first one of the plurality of side walls.

11. The method of forming a plastic box of claim 10 wherein the forming a score line step comprises applying a rotary ultrasonic horn against the blank.

12. The method of forming a plastic box of claim 10 wherein the forming a score line step comprises applying a plunge ultrasonic horn against the blank.

13. The method of forming a plastic box of claim 10 wherein the forming a score line step comprises applying heat and pressure to the blank.

14. The method of forming a plastic box of claim 11 wherein the ultrasonic horn includes a contact segment having a radius of 0.01 inches.

15. The method of forming a plastic box of claim 10 wherein the blank includes a second flap extending from a second one of the plurality of side walls, and the method further comprises:
forming a score line between the second flap and the second one of the plurality of side walls sufficiently wide such that the second flap is configured to lay flat against an outer surface of the second one of the plurality of side walls without spring back when the second flap is folded against the outer surface of the second one of the plurality of side walls.

16. The method of forming a plastic box of claim 15 wherein the blank includes a third flap extending from a third one of the plurality of side walls, and the method further comprises:
forming a score line between the third flap and the third one of the plurality of side walls sufficiently wide such that the third flap is configured to lay flat against an outer surface of the third one of the plurality of side walls without spring back when the third flap is folded against the outer surface of the third one of the plurality of side walls.

17. The method of forming a plastic box of claim 16 wherein the blank includes a fourth flap extending from a fourth one of the plurality of side walls, and the method further comprises:
forming a score line between the fourth flap and the fourth one of the plurality of side walls sufficiently wide such that the fourth flap is configured to lay flat against an outer surface of the fourth one of the plurality of side walls without spring back when the fourth flap is folded against the outer surface of the fourth one of the plurality of side walls.

18. The method of claim 17 wherein the step of providing a blank of corrugated plastic material comprises:
extruding a sheet of plastic having a first outer layer, a second outer layer and a plurality of flutes between the first outer layer and the second outer layer.

19. The method of claim 18 wherein the step of providing a blank of corrugated plastic material comprises:
forming fold lines on the sheet to form the plurality of side walls; and,
cutting the sheet to form flaps extending from each of the plurality of side walls.

20. The method of claim 19 further comprising the step of forming the blank into a box shape.
